(19) United States
(12) Patent Application Publication
(10) Pub. No.: US 2008/0001543 A1
(43) Pub. Date: Jan. 3, 2008

(54) Metal Halide Lamp and Lighting Equipment

(76) Inventors: Takahito Kashiwagi, Yokosuka-shi (JP); Masazumi Ishida, Yokosuka-shi (JP); Mikio Matsuda, Arakawa-ku (JP); Kozo Uemura, Yokosuka-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/662,499

(22) PCT Filed: Oct. 28, 2005
(86) PCT No.: PCT/JP05/19910

§ 371 Date: Mar. 12, 2007

(30) Foreign Application Priority Data
Oct. 29, 2004 (JP) 2004-317276
Dec. 17, 2004 (JP) 2004-366196
Dec. 24, 2004 (JP) 2004-374760

(51) Int. Cl. H01J 61/18

(52) U.S. Cl. 313/638

(57) ABSTRACT

This invention provides a metal halide lamp and a lighting equipment that, despite the fact that mercury is not filled, can provide electrical characteristics comparable with a mercury-contained metal halide lamp and can provide luminescent characteristics favorably comparable with the mercury-contained metal halide lamp. A metal halide lamp MHL includes a hermetically sealed vessel 1, a pair of electrodes 2, and a discharge medium filled in the hermetically sealed vessel. The discharge medium contains a first halide, a second halide, and a rare gas. The first halide is composed mainly of a halide of a luminescent metal and contains a halide of thulium (Tm) filled at the highest filling ratio in all of metal halides filled in the hermetically sealed vessel, and the content of an alkali metal halide in the first halide is less than 10% by mass at the highest. The second halide is composed mainly of a metal halide for constituting a lamp voltage, and the content of the second halide is 5 to 20% by mass with respect to all of the metal halides filled in the hermetically sealed vessel. The discharge medium is substantially free from mercury.

### TECHNICAL FIELD

The present invention relates to a metal halide lamp that is substantially free from mercury, and a lighting equipment using the same.

### BACKGROUND ART

It is known that a high-efficiency/long duration metal halide lamp that can suppress a fluctuation in a luminous color, improve lamp life duration characteristics, and is of a lighting direction free type is acquired when an arc tube shape parameter value Le/φi satisfies a range of 0.45 to 0.65, where Le (mm) is an inter-electrode distance in a luminous portion and φi (mm) is a tube internal diameter of the luminous portion at the center, the metal halide lamp being a low-watt type metal halide lamp comprising: the luminous portion having a pair of electrodes therein; and the arc tube having narrow-tube portions at both ends of the luminous portion and formed of a ceramic material, the arc tube having a metal halide therein as a fill, the metal halide containing at least one of a dysprosium halide, a thulium halide, a holmium halide, and a cerium halide, and a sodium halide. (see Patent Document 1)

Further, a metal halide lamp that is substantially free from mercury is already known (see, e.g., Patent Document 2). The metal halide lamp disclosed in Patent Document 2 has a second halide that is a halide of a metal that produces luminescence mainly in a visible range as well as a first halide filled therein in place of mercury, the second halide being a halide of a metal that has a relatively high steam pressure and is hard to produce luminescence in the visible range as compared with a metal of the first halide.

Furthermore, Patent Document 2 discloses, as Embodiment 1, a metal halide lamp for a liquid crystal projector that has an inter-electrode distance of 4 mm, contains a first halide and a rare gas filled therein, and is turned on with an input power of 150 W, the first halide being 1 mg of a dysprosium iodide (DyI₃) and 1 mg of a neodymium iodide (NdI₃), the rare gas being 500 Torr of argon (Ar). In this embodiment, when 8 mg of, e.g., a zinc iodide (ZnI₂) is filled as a second halide, a lamp voltage is 73 V, a luminous efficiency is 68 μm/W, and a color temperature is 9160 K.

Moreover, Patent Document 2 discloses, as Embodiment 8, a metal halide lamp that has an inter-electrode distance of 30 mm, contains a first halide and a rare gas filled therein, and is turned on with an input power of 2 kW, the first halide being 4 mg of each of a dysprosium bromide (DyBr₃), a holmium bromide (HoBr₃), and a thulium bromide (TmBr₃), the rare gas being 100 Torr of argon (Ar). In this embodiment, when 30 mg of, e.g., zinc iodide (ZnI₂) is filled as a second halide, a lamp voltage is 112 V, a luminous efficiency is 92 μm/W, a color temperature is 5340 K, and an average color rendering index Ra is 73.

On the other hand, when sodium (Na) is used to realize a warm white luminous color having a color temperature of approximately 3500 K or a neutral white luminous color having a color temperature of 3900 to 4200 K, there is a problem that sodium is readily dispersed because it has a small ion radius, and hence it is known that a metal halide in a first group has a boiling point that is equal to or above 1000° C. and at least dysprosium (Dy) and calcium (Ca) are used. (see Patent Document 3)

Patent Document 1: Japanese Unexamined Patent Application Publication No. 2003-272560

Patent Document 2: Japanese Unexamined Patent Application Publication No. H11 (1999)-238488

Patent Document 3: Japanese Unexamined Patent Application Publication No. 2001-076670

### DISCLOSURE OF INVENTION

### Problem to be Solved by the Invention

According to the invention disclosed in Patent Document 1, mercury must be filled as a buffer gas, and using an environmental load material is not preferable.

According to the invention disclosed in Patent Document 2, the metal halide lamp having electrical characteristics and luminescent characteristics substantially equal to those of a conventional metal halide lamp containing mercury was obtained without using mercury that has a large environmental load. However, emergence of a metal halide lamp that is substantially free from mercury and has a luminous efficiency equal to or above that in a conventional technology has been expected.

Although sodium is used as a material that produces white-color-based luminescence with a high efficiency, the sodium D-line has a wavelength of 589 nm and is separated from 555 nm as a peak wavelength of a luminosity curve, and hence the efficiency must be further improved.

On the other hand, in order to improve the luminous efficiency in the metal halide lamp, a method of increasing a temperature in a coolest portion in an arc tube is generally known besides the method of using sodium as a luminescent metal as explained above.

However, since there are various limitations in, e.g., heat-resisting properties of a hermetically sealed vessel constituting an arc tube or responsiveness of sodium, a great improvement in the luminous efficiency is difficult when the above-explained means alone is used. Additionally, in case of a metal halide lamp that is free from mercury (which will be referred to as “a mercury-free lamp” hereinafter for the convenience's sake), sodium contributes to the luminous efficiency but it becomes a factor of reducing a potential gradient between electrodes and hence a lamp voltage. When a discharge medium contains a large amount of sodium, since a lamp voltage becomes low, a lamp current must be increased in order to input a desired lamp power. As a result, there is a difficulty in a design of each electrode or the hermetically sealed vessel, e.g., increasing an electrode axial diameter, and there is also a problem of a difficulty in a design of a stabilizer.

Meanwhile, in case of Patent Document 2, the metal halide lamp having electrical characteristics and luminescent characteristics substantially equal to those in a conventional metal halide lamp can be obtained, but a luminous efficiency is substantially equivalent to that of a metal halide lamp containing mercury.

Further, in case of Patent Document 3, since dysprosium and calcium must be used, a color rendering index R9 is high, but a luminous efficiency is as very low as 60 μm/W.

It is an object of the present invention to provide a metal halide lamp having electrical characteristics equal to those of a metal halide lamp containing mercury and having luminescent characteristics substantially equal to or superior to those of the same even though mercury is not contained.

### Means for Solving Problem

According to a first aspect of the present invention, there is provided a metal halide lamp comprising: a light-transmitting hermetically sealed vessel having a discharge space therein; a pair of electrodes that are sealed and disposed in the hermetically sealed vessel and face the discharge space; and a discharge medium containing a first halide, a second halide, and a rare gas, the first halide being mainly composed of a halide of a luminescent metal and containing a thulium (Tm) halide at the highest filling ratio in all of metal halides filled in the hermetically sealed vessel, a content of an alkali metal halide being less than 10% by mass, the second halide being mainly composed of a metal halide that forms a lamp voltage, a content of the second halide being 5 to 20% by mass with respect to all the metal halides filled in the hermetically sealed vessel, the discharge medium being filled in the hermetically sealed vessel without substantially containing mercury.

[Hermetically Sealed Vessel] In the present invention, when the hermetically sealed vessel has translucency, this means that visible light in a desired wavelength band produced by discharge is led to the outside. The hermetically sealed vessel may be formed of any material as long as it is a material that has translucency and fire-resisting properties that can sufficiently resist a regular yield temperature of a lamp. For example, quartz glass or light-transmitting ceramics can be used. It is to be noted that, as the light-transmitting ceramics, light-transmitting alumina, yttrium-aluminum-garnet (YAG), a yttrium oxide (YOX), or a polycrystal non-oxide, e.g., polycrystal or single-crystal ceramics like an aluminum nitride (AlN) can be used. It is to be noted that a transparent coating film having halogen-resisting properties or metal-resisting properties can be formed on an inner surface of the hermetically sealed vessel or the inner surface of the hermetically sealed vessel can be modified as required.

Further, the hermetically sealed vessel has a discharge space therein. Furthermore, the hermetically sealed vessel has an enclosure portion to enclose the discharge space. The inside of the enclosure portion has an appropriate shape, e.g., a spherical shape, an elliptic spherical shape, or a substantially cylindrical shape. As a volume of the discharge space, various values can be selected in accordance with a rated lamp power, an inter-electrode distance, and others of the metal halide lamp. For example, in case of a liquid crystal projector lamp, the volume can be set to 0.1 cc or below. In case of a car headlamp, the volume can be set to 0.05 cc or below. Moreover, in case of a general illumination lamp, either a value that is not smaller than 1 cc or a value that is not greater than 1 cc can be used in accordance with a rated lamp power.

Additionally, a pair of sealing portions is allowed to be provided at both ends of the enclosure portion. The pair of sealing portions is means that seals the enclosure portion, has a shaft portion of each electrode supported thereon, and air-tightly leads a current to each electrode from a lighting circuit, and this means is generally arranged at both ends of the enclosure portion. When a material of the hermetically sealed vessel is quartz glass, a sealing metal foil is preferably air-tightly embedded in the sealing portion as hermetically sealing conducting means in order to fill and attach each electrode and air-tightly lead a current from the lighting circuit to each electrode. It is to be noted that the sealing metal foil is means that is embedded in the sealing portion and functions as a current conductor in cooperation with the sealing portion when the sealing portion maintains air-tightness in the enclosure portion of the hermetically sealed vessel, and molybdenum (Mo) is optimum as a material when the hermetically sealed vessel is formed of quartz glass. Although a method of embedding the sealing metal foil in the sealing portion is not restricted in particular, an evacuation sealing method, a pinch sealing method, or a combination of these methods can be appropriately selected and adopted.

On the other hand, as sealing means when the hermetically sealed vessel is formed of light-transmitting ceramics, it is possible to use, e.g., frit sealing of flowing a frit material to a space between the light-transmitting ceramics and an introducing conductor to effect sealing or metal sealing of using a metal in place of the frit material. Further, in order to maintain a temperature of the coolest portion in the discharged space formed in the hermetically sealed vessel to a desired relatively high temperature while maintaining the sealing portion of the hermetically sealed vessel to a necessary relatively low temperature, a small-diameter cylindrical portion communicating with the enclosure portion can be formed. In case of this structure, the sealing portion is arranged at an end of the small-diameter cylindrical portion, and a shaft of each electrode is extended to the inside of the small-diameter cylindrical portion to form a small gap called a capillary rally between the electrode shaft and an inner surface of the small-diameter cylindrical portion along an axial direction of the small-diameter cylindrical portion.

[Pair of Electrodes] In the present invention, each of the pair of electrodes is disposed in the hermetically sealed vessel and arranged to face the discharge space with a gap interposed therebetween. An inter-electrode distance formed between the pair of electrodes is preferably 2 mm or below in case of, e.g., a liquid crystal projector, or it may be 0.5 mm. For a headlight, 4.2 mm is standardized as a central value. In case of a general illumination lamp, this distance can be set to 6 mm or below when the lamp is small and has a short inter-electrode distance, and the same can be set to 6 mm or above when the lamp has a medium or a large size.

Furthermore, in regard to a constituent material of the electrode, the electrode can be formed by using an electroconductive metal having fire-resisting properties, e.g., pure tungsten (W), doped tungsten containing a doping agent (one or more types selected from a group including scandium (Sc), aluminum (Al), potassium (K), silicon (Si), and others), thoriated tungsten containing a thorium oxide, rhenium (Re), or a tungsten-rhenium (W—Re) alloy.

Moreover, in case of a small lamp, a straight-bar-shaped wire rod or a wire rod having a large-diameter portion at a distal end can be used as the electrode. In case of a medium or a large electrode, a coil formed of an electrode component can be wound around a distal end of an electrode shaft. It is to be noted that the pair of electrodes can have the same structure when they operate with an alternating current, but the electrode having a radiation area larger than that of a cathode, i.e., having a thick main portion can be used when they operate with a direct current since a temperature of an anode generally intensively increases.

[Discharge Medium] The discharge medium is a characteristic constituent member in the first aspect of the present invention, and configured to contain a first and a second halides and a rare gas.

(First Halide) The first halide contains at least thulium (Tm) as a main component, and a halide of an alkali metal is determined to have a predetermined amount or below. Additionally, the first halide is constituted of a halide of a metal that mainly contributes to luminescence of visibly light.

It is determined that the thulium (Tm) halide is filled at the maximum filling ratio with respect to all metal halides filled in the hermetically sealed vessel. Further, the thulium halide itself has a potential gradient between the electrodes and hence has a function of increasing a lamp voltage in coexistence with a later-explained second halide, and the thulium halide is a halide of a luminescent metal that is preferable for the mercury-free lamp. As halogen of the thulium halide, iodine is preferable since it has appropriate responsiveness, but one of bromine and chlorine may be used as desired, and desired two or more of iodine, bromine, and chlorine may be used. Furthermore, since a luminescent peak of thulium matches with a peak of a luminosity curve, thulium is a luminescent metal that is very effective to improve the luminous efficiency.

A halide of an alkali metal is allowed to be filled within a range of less than 10% by mass (including 0%) with respect to all metal halides filled in the hermetically sealed vessel. When a filling ratio of the alkali metal becomes 10% or more by mass, a lamp voltage is apt to be reduced, and hence this is not preferable in terms of formation of the lamp voltage. However, when the filling ratio is less than 10% by mass, a reduction in the lamp voltage can be suppressed to the minimum level and, on the other hand, an improvement in a luminous efficiency and a lamp life duration, adjustment of a luminous color and, especially an improvement in color deviation can be realized. In this viewpoint, when a necessary lamp voltage can be assured, filling is allowed within the above-described range. It is not be noted that the filling ratio is preferably 2 to 8% by mass, or preferably 3 to 7% by mass, or more preferably 4 to 6% by mass.

Moreover, as the alkali metal, it is possible to selectively fill one or more types in a group including sodium (Na), cesium (Cs), and lithium (Li) It is to be noted that sodium (Na) mainly contributes to an improvement in a luminous efficiency. Cesium (Cs) contributes to an improvement in life characteristics based on adequacy of a discharge arc temperature. Lithium (Li) contributes to an improvement in red rendering properties.

Additionally, as the first halide, the following metal halides can be filled.

(1) One or More Halides of Rare-Earth Metals Consisting of Praseodymium (Pr), Cerium (Ce), and Samarium (Sm).

The rare-earth metal is useful as a luminescent metal that is second to the thulium halide, and can be filled at a filling ratio that is equal to or below a predetermined amount. That is, since any one of the rare-earth metals has countless numbers of bright line spectrums near a peak wavelength of a luminosity characteristic curve, it can contribute to an improvement in a luminous efficiency.

(2) Halide of Thallium (Tl) and/or Indium (In)

This halide is allowed to be selectively filled as an accessory constituent in order to obtain, e.g., desired color rendering properties and/or a color temperature.

(Second Halide) The second halide has a steam pressure higher than that of the first halide, and mainly determines a lamp voltage in the metal halide discharge lamp. It is to be noted that “a steam pressure is large” means that a steam pressure during lighting is high, but the steam pressure does not have to be extremely high like mercury, and a pressure in the sealed vessel during lighting is preferably approximately 5 atmospheres or below. Therefore, when the above-explained conditions are provided, the present invention is not restricted to a specific metal halide.

Further, the second halide is constituted of a metal halide mainly forming a lamp voltage, and it is possible to primarily use halides of one or more metal selected from a group including, e.g., magnesium (Mg), iron (Fe), cobalt (Co), chrome (Cr), zinc (Zn), nickel (Ni), manganese (Mn), aluminum (Al), antimony (Sb), beryllium (Be), rhenium (Re), gallium (Ga), titanium (Ti), zirconium (Zr), and hafnium (Hf). Furthermore, almost all of these materials have a steam pressure lower than that of mercury, and a lamp voltage adjustment range narrower than that of mercury. However, when the plurality of materials are mixed and filled as required, the lamp voltage adjustment range can be increased. For example, when AlI₃ is in an incomplete evaporation state and a desired lamp voltage is not obtained, the lamp voltage does not change even if AlI₃ is added.

On the contrary, when ZnI₂ is added in place of addition of AlI₃, a lamp voltage produced to due to a function of ZnI₂ is added, thereby increasing the lamp voltage. Moreover, when any other second halide is added, a higher lamp voltage can be obtained.

Additionally, the second halide is also a metal halide that hardly produces luminescence in a visible range as compared with a metal of the first halide. The phrase “hardly produces luminescence in a visible range as compared with a metal of the first halide” does not mean that luminescence of visible light is insufficient in an absolute sense but in a relative sense. That is because Fe or Ni surely produces more luminescence in an ultraviolet range than luminescence in a visible range, but Ti, Al, Zn and others produce more luminescence in the visible range. Therefore, when such a metal that produces more luminescence in the visible range is solely allowed to generate luminescence, energy is concentrated on this metal, thereby increasing luminescence in the visible range. However, if an energy level of the second halide is higher than that of the first halide and the second halide is thereby hard to produce luminescence, an energy is concentrated on luminescence of the first halide in a state where both the first and the second halides are present, thus decreasing luminescence of a metal of the second halide.

Therefore, the second halide is not prohibited to produce luminescence of visible light, but it has a small ratio with respect to all visible lights emitted from the discharge lamp, and hence it gives less influence.

Further, a filling ratio of the second halide must be 5 to 20% by mass with respect to all metal halides filled in the hermetically sealed vessel. When the filling ratio is less than 5% by mass, formation of a lamp voltage becomes insufficient. Furthermore, when the filing ratio exceeds 20% by mass, formation of a lamp voltage has no problem, but a reduction in a luminous efficiency becomes considerable.

(Rare Gas) A rare gas mainly functions as a buffer gas and a starting gas. Moreover, one selected from a group including neon (Ne), argon (Ar), xenon (Xe), krypton (Kr), and others can be solely filled, or a plurality of gasses selected from this group can be mixed and filled. A filling pressure of the rare gas can be appropriately set in accordance with an application of the metal halide lamp.

Of the rare gases, xenon has a relatively small thermal conductivity since it has an atomic mass larger than the other rare gases, and hence filling xenon at 1 atmospheres or above, or preferably 5 atmospheres or above can contribute to formation of a lamp voltage immediately after lighting, and xenon produces luminescence of white visible light when a steam pressure of a halide is low, which contributes to rising of a light flux. Therefore, xenon is effective in case of a metal halide lamp for a headlight. In this case, a preferable filling pressure of xenon is not lower than 6 atmospheres, or more desirably a range of 8 to 16 atmospheres. Therefore, xenon can satisfy rising of a light flux immediately after lighting and standards for white luminescence as an HID light source for a vehicle headlight.

(Mercury) In the present invention, containing no mercury (Hg) is desirable for a reduction of environmental load materials, but containing mercury like an impurity is allowed.

[Other Structures] In the present invention, the following structures can be selectively added as desired.

1. (Outer Tube) A constituent part including the hermetically sealed vessel, the pair of electrodes, and the discharge medium is determined as an arc tube, and it can be arranged in an outer tube. The outer tube can have any desired shape and size. Further, the inside of the outer tube may be air-tight without respect to the outside, or it may communicate with outside air. In the former case, an inert gas, e.g., argon or nitrogen can be filled as required. Furthermore, the outer tube can be formed of a light-transmitting material, e.g., quartz glass, hard glass, or soft glass.

2. (Reflection Mirror) The hermetically sealed vessel can be fixedly arranged at a predetermined position in a reflection mirror. It is to be noted that, as the reflection mirror, one having a dichroic mirror formed on an inner surface of a glass substrate can be used.

[Effect in First Aspect According to Present Invention] In the first aspect according to the present invention, since the discharge medium contains a halide of thulium (Tm) filled at a maximum filling ratio among all metal halides filled in the hermetically sealed vessel, luminescence by thulium is dominant in luminescence of the metal halide lamp. Since luminescence by thulium has many bright line spectrums near a peak wavelength 555 nm of a luminosity curve, a high luminous efficiency can be obtained as a whole.

Moreover, the present inventor has discovered that an ionization potential of thulium is higher than that of an alkali metal, e.g., sodium, filling a thulium halide does not become a factor of reducing a lamp voltage, and thulium amazingly has a function of increasing a lamp voltage in proportion to a filling amount when it is preset together with the second halide. When a lamp voltage is high, an increase in a lamp current can be readily avoided when inputting a necessary lamp power, thereby facilitating design of the electrodes or the hermetically sealed vessel.

Additionally, in the first aspect according to the present invention, a rated lamp power of the metal halide lamp can be freely set from values in a wide range, and it can be set to any value that is, e.g., several kW or below. In applications, versatility is allowed, and the present invention is suitable for, e.g., a vehicle headlight, a projection, or a general illumination. Therefore, the hermetically sealed vessel having an appropriate shape and size, an inter-electrode distance having an appropriate value, and a discharge medium filling amount having an appropriate value can be provided in accordance with a rated lamp power and an application.

According to a second aspect of the present invention, there is provided a metal halide lamp comprising: a light-transmitting hermetically sealed vessel having fire-resisting properties and a discharge space therein; a pair of electrodes that are sealed and disposed in the hermetically sealed vessel and face the discharge space; and a discharge medium containing a first halide, a second halide and a rare gas, the first halide being mainly composed of a halide of a luminescent metal and containing a thulium (Tm) halide at the highest filling ratio in all metal halides filled in the hermetically sealed vessel, the second halide being mainly composed of a metal halide that forms a lamp voltage, a content of the second halide being 5 to 20% by mass with respect to all the metal halides filled in the hermetically sealed vessel, ionization potentials of metals forming all the metal halides being not lower than 5.4 eV, and the discharge medium being filled in the hermetically sealed vessel without substantially containing mercury.

According to the second aspect of the present invention, the first and the second metal halides are defined to be selected and filled based on values of ionization potentials thereof, and an ionization potential (eV) of a metal that can be filled as a halide in the hermetically sealed vessel is shown in parentheses following a metal element symbol.

(1) Metals of the first halide: Tm (6.18), Pr(5.42), Ce(5.47), Sm(5.63), In(5.786), and Tl(6.108).

(2) Metals of the second halide: Mg(7.644); Fe(7.87), Co(7.864), Cr(6.765), Zn(9.394), Ni(7.635), Mn(7.432), Al(5.986), Sb(8.642), Bi(7.287), Re(9.323), Ga(5.999), Ti(6.84), and Zr(6.837), Hf(7)

On the other hand, an ionization potential of an alkali metal, e.g., Na (an ionization potential: 5.14 eV) or Li (5.392) is less than 5.4 eV, an a lamp voltage is reduced as a filling amount is increased. Therefore, in this mode, the alkali metal is not substantially contained.

According to a third aspect of the present invention, in the metal halide lamp according to the first or the second aspect, the metal halide lamp is characterized in that a filling ratio H_{Tm} (% by mass) of a thulium (Tm) halide in the discharge medium with respect to all metal halides filled in the hermetically sealed vessel satisfies the following expression:
30<H_{Tm}<90

In the third aspect of the present invention, in order to achieve the object of the present invention, a range of the filling ratio H_{Tm} of the thulium halide that can be generally adopted with respect to all halides is defined. When the filling ratio H_{Tm} is less than 30% by mass, the effect of the present invention is reduced. Furthermore, when this ratio exceeds a 90-mass range, a luminous efficiency has no problem, but a desired value of a color temperature or chromaticity is hard to be obtained. It is to be noted that this range is preferably a range of 50 to 80% by mass. When the filling ratio H_{Tm} exceeds 80% by mass, the luminous efficiency and formation of a lamp voltage have no problem, but forming pellets becomes difficult, thereby increasing a manufacturing cost.

According to a fourth aspect of the present invention, in the metal halide lamp defined in one of the first to the third aspects, the metal halide lamp is characterized in that the first halide in the discharge medium contains one or more halides of rare-earth metals selected from a group including praseodymium (Pr), cerium (Ce), and samarium (Sm), and a filling ratio of the rare-earth metal halide as well as the thulium (Tm) halide with respect to all halides is not smaller than 50% by mass.

The fourth aspect of the present invention defines the rare-earth metal halides that are allowed to be filled except the thulium (Tm) halide and a preferable filling ratio range when filling these halides. That is, any metal in the group including praseodymium (Pr), cerium (Ce), and samarium (Sm) has a bright line spectrum near a peak of a luminosity curve, and these metal halides substitute for a part of the thulium halide, or these halides are added together with the thulium halide. That is, the rare-earth metal halide can be filled as an accessory constituent with respect to the thulium halide.

In regard to a generally adoptable filling ratio range of the rare-earth metal halides included in the group, when the entire rare-earth metal halides including the thulium (Tm) halide have a filling ratio that is not smaller than 50% by mass with respect to all metal halides filled in the lamp, this is preferable to achieve the object of the present invention.

According to a fifth aspect of the present invention, in the metal halide lamp according to one of the first to the fourth modes, the metal halide lamp is characterized in that the first halide in the discharge medium contains at least one of a thulium (Tl) halide and an indium (In) halide.

The thulium (Tl) halide can add a green component of thulium having a bright line in a wavelength of 535 nm to luminescence. In case of this mode, a generally adoptable thulium halide filling ratio range is less than 30% by mass with respect to all metal halides to be filled. When the thulium halide filling ratio range becomes equal to or above 30% by mass, a reduction in a luminous efficiency becomes considerable. It is to be noted that, preferably, filling the thulium halide within the range of less than 15% by mass can suffice.

Furthermore, when the indium (In) halide is added, a blue component can be increased in luminescence of the halide, and addition of this halide also contributes to formation of a lamp voltage.

According to the present invention, there is provided a lighting equipment comprising: a lighting equipment main body; a metal halide lamp arranged in the lighting equipment main body; and a lighting device that turns on the metal halide lamp.

In the present invention, the lighting equipment is a concept including all equipments using a metal halide lamp as a light source. For example, this corresponds to various kinds of outdoor and indoor lighting equipments, a vehicle headlight, an image or a picture projection device, a marker lamp, a signal lamp, an indicator, a chemical reaction device, an inspection device, and others.

The lighting equipment main body means a part in the lighting equipment excluding the metal halide lamp and a lighting circuit.

Using a computerized lighting device as the lighting device is preferable since control over the metal halide lamp is facilitated. Moreover, the lighting device may be arranged not only in the lighting equipment main body but also at a position apart from the lighting equipment main body.

### EFFECT OF THE INVENTION

According to the present invention, since the thulium halide is filled at the maximum filling ratio and the second halide is also filled, it is possible to provide the metal halide lamp and the lighting equipment using the same by which luminescence by thulium becomes dominant to increase a luminous efficiency, a lamp voltage can be increased, electrical characteristics equivalent to those of a mercury-contained metal halide lamp can be provided even though mercury is not filled, and the luminous efficiency that is substantially equal to or superior to that of the mercury-contained metal halide lamp.

### BRIEF DESCRIPTION OF DRAWINGS

FIG. 1 is a front view showing a first embodiment that carries out a metal halide lamp according to the present invention;

FIG. 2 is a graph showing a relationship between a potential gradient and a luminous efficiency with types and filing ratios of metal halides to be filled being as parameters;

FIG. 3 is a front view showing a second embodiment that carries out a metal halide lamp according to the present invention;

FIG. 4 is a process drawing showing a procedure when sealing a light-transmitting ceramics arc tube according to the second embodiment depicted in FIG. 3;

FIG. 5 is a conceptual view showing the first embodiment of a sealing device for a hermetically sealed vessel made of light-transmitting ceramics;

FIG. 6 is a conceptual view showing the second embodiment of a sealing device for the hermetically sealed vessel made of light-transmitting ceramics;

FIG. 7 is a conceptual view showing a third embodiment of a sealing device for the hermetically-sealed vessel made of light-transmitting ceramics;

FIG. 8 is a conceptual front view and plan view showing the first embodiment of sealing of the hermetically sealed vessel made of light-transmitting ceramics;

FIG. 9 is a conceptual front view and plan view showing the second embodiment of sealing of the hermetically sealed vessel made of light-transmitting ceramics;

FIG. 10 is a conceptual front view showing the third embodiment of sealing of the hermetically sealed vessel made of light-transmitting ceramics; and

FIG. 11 is a conceptual partially cross-sectional front view showing a fourth embodiment of sealing of the hermetically sealed vessel made of light-transmitting ceramics.

### EXPLANATION OF LETTERS OF NUMERALS

1 . . . hermetically sealed vessel, 1a . . . enclosure portion, . . . sealing potion, 1b . . . electrode, 1c . . . discharge space, 2 . . . sealing metal foil, 3A and 3B . . . external lead wires, B . . . mouth ring, IT . . . arc tube, MHL . . . metal halide lamp, OT . . . outer tube, T . . . insulating tube

### BEST MODES FOR CARRYING OUT THE INVENTION

Modes for carrying out the present invention will now be explained hereinafter with reference to the accompanying drawings.

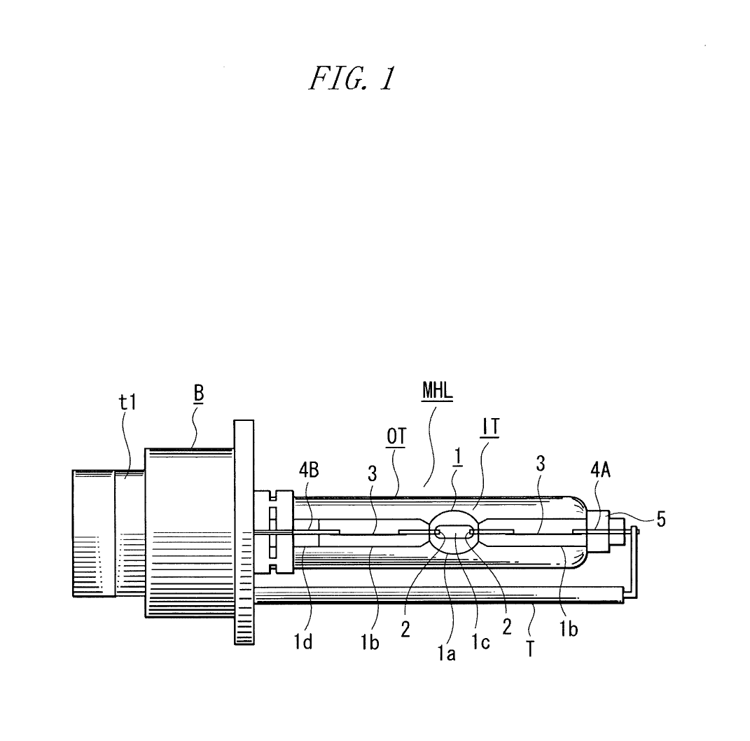

FIG. 1 is a front view showing a first embodiment that carries out a metal halide lamp according to the present invention. This embodiment provides a metal halide lamp for a vehicle headlight as one application, and a metal halide lamp MHL includes an arc tube IT, an insulating tube T, an outer tube OT, and a mouth ring B in the drawing and is horizontally turned on.

The arc tube IT includes a hermetically sealed vessel 1, a pair of electrodes 2 and 2, a sealing metal foil 3, a pair of external lead wires 4A and 4B, and a discharge medium.

The hermetically sealed vessel 1 is made of quartz glass, and includes an enclosure portion 1a and a pair of sealing portions 1b and 1b. The enclosure portion 1a is hollow, has an outer shape molded into a spindle-like form, has a pair of elongated sealing portions 1a1 integrally formed at both ends thereof, and has a substantially cylindrical elongated discharge space 1c formed therein. An internal volume of the discharge space 1c is not greater than 0.1 cc. It is to be noted that, in the drawing, the left sealing portion 1b is formed, and then the sealing tube 1d is integrally extended from an end of the sealing portion 1b without being cut and enters the mouth ring B.

Each of the pair of electrodes 2 and 2 is formed of a doped tungsten line and has the same diameter in a shaft portion from a distal end and a middle portion to a proximal end along an axial direction, and the distal end and the middle portion are partially exposed in the discharge space 1c. Further, the proximal end of the electrode 2 is welded to the later-explained sealing metal foil 3 embedded in the sealing portion 1b, and the middle portion is loosely supported by the sealing portion 1b, thereby arranging the electrode at a predetermined position in the hermetically sealed vessel 1.

The sealing metal foil 3 is made of a molybdenum foil, and air-tightly embedded in the sealing portion 1b of the hermetically sealed vessel 1.

The discharge medium is made of metal halides and a rare gas.

The metal halides contain a first halide, a second halide that mainly contributes to formation of a lamp voltage, and a rare gas.

The first halide mainly contributes to producing desired luminescence, and contains at least a thulium (Tm) halide at a maximum filling ratio with respect to all metal halides filled in the hermetically sealed vessel 1. Furthermore, appropriate amounts of, e.g., a rare-earth element metal halide other than thulium, thallium (Tl), indium (In), and/or an alkali metal halide are filled as desired.

The second halide is a halide of a metal that has a relatively large steam pressure and hardly produces luminescence in a visible range as compared with the first halide. Hardly producing luminescence in the visible range means that an influence given to a luminescent color of the entire lamp is small and radiation of visible light by a metal constituting the second halide is small. For example, the second halide is formed of halides of one or more metals selected from the following group. Furthermore, the second halide consists of, e.g., magnesium (Mg), iron (Fe), cobalt (Co), chrome (Cr), zinc (Zn), nickel (Ni), manganese (Mn), aluminum (Al), antimony (Sb), bismuth (Bi), beryllium (Be), rhenium (Re), gallium (Ga), titanium (Ti), zirconium (Zr), and hafnium (Hf).

The rare gas is selected from, e.g., neon (Ne), argon (Ar), xenon (Xe), and krypton (Kr).

A distal end of each of the pair of external lead wires 4A and 4B is welded to the other end of the sealing metal foil 3 in the sealing portion 1b at each of both ends of the hermetically sealed vessel 1, and a proximal end of the same is led to the outside. In the drawing, a middle portion of the external lead wire 4A led to the right-hand side from the discharge vessel IT is bent along the later-explained outer tube OT, and the external lead wire 4A is led into the later-described mouth ring B to be connected with one annular mouth ring terminal t1 arranged on an outer peripheral surface of the mouth ring B. Moreover, in the drawing, the external lead wire 4B led to the left-hand side from the discharge vessel IT is extended along a tube axis to be led into the mouth ring B, and connected with the other non-illustrated pin-like mouth ring terminal arranged at the center.

The outer tube OT has an ultraviolet protecting performance and accommodates the discharge vessel IT, and each of reduced-diameter portions 5 at both ends (the drawing shows one end on the right-hand side alone) is glass-welded to the sealing portion 1b of the discharge vessel IT. However, the inside of the outer tube OT is not airtight, but communicates with outside air.

The insulating tube T is formed of a ceramics tube, and covers the external lead wire 4A.

The mouth ring B is standardized as a vehicle headlight, supports the discharge vessel IT and the outer tube OT along a central axis in an upright manner, and is detachably disposed on a rear surface of the vehicle headlight. Additionally, at the time of attachment, the mouth ring B includes one annular mouth ring terminal t1 arranged on the cylindrical outer peripheral surface and the other pin-like mouth ring terminal arranged to protrude in the axial direction at the center in a concave portion with one opened end formed in the cylindrical portion so as to allow connection with a lamp socket (not shown) on a power supply side.

### EXAMPLE 1

Example 1 is a metal halide lamp for a vehicle headlight shown in FIG. 1.

Hermetically sealed vessel 1: maximum external diameter 6.5 mm, spherical length 6.5 mm, maximum internal diameter 2.4 mm, internal volume 0.025 cc

Pair of electrodes: made of doped tungsten, axial diameter 0.3 mm, entire length 10 mm, inter-electrode distance 4.2 mm

Discharge medium: ZnI₂(12.1)-InI(3.1)-TlI(12.1)-TmI₃(64.2)-LiI(8.5)=0.7 mg, a numeric character in parentheses means a filling ratio (% by mass), Xe 13 atmospheres

Electrical characteristics: lamp voltage 66.7 V, lamp current 0.584 A, a lamp power 38.9 W

Luminescent characteristics: total light flux 3983 μm, luminous efficiency 102.4 μm/W, color temperature 4827 K, average color rendering index Ra 85.9

### COMPARATIVE EXAMPLE 1

Discharge medium: Hg 0.2 mg-ScI₃(16.67)-NaI(83.33)=0.3 mg, a numerical character in parentheses means a filling ratio (% by mass), Xe 5 atmospheres

Other specifications are the same as Example 1.

Electrical characteristics: lamp voltage 85.0 V, lamp current 0.412 A, a lamp power 35.0 W

Luminescent characteristics: total light flux 3550 μm, luminous efficiency 101.4 μm/W, color temperature 4200 K, average color rendering index Ra 65.0

As can be understood from the specifications, the electrical characteristics, and the luminescent characteristics, Comparative Example 1 corresponds to a current mercury-contained metal halide lamp for a vehicle headlight.

On the other hand, according to Example 1, the lamp voltage in the electrical characteristics is close to or substantially equal to that of the comparative example rather than a known mercury-free lamp, and the total light flux and the average color rendering index Ra in the luminescent characteristics are clearly excellent. Moreover, the luminous efficiency is slightly high, and the color temperature is a value close to a daylight white color (5000 K).

### EXAMPLE 2

Discharge medium: ZnI₂(13.8)-InI(3.4)-TlI(13.8)-TmI₃(69.0)=0.5 mg, a numerical character in parentheses means a filling ratio (% by mass), Xe 13 atmospheres

Other specifications are the same as Example 1.

Electrical characteristics: lamp voltage 78.0 V, lamp current 0.500 A, lamp power 38.9 W

Luminescent characteristics: total light flux 3841 μm, luminous efficiency 98.7 μm/W, color temperature 5158 K, average color rendering index Ra 81.0

According to Example 2, the electrical characteristics are substantially equal to those in Comparative Example 1, and the total light flux and the average color rendering index Ra in the luminescent characteristics are clearly excellent. Additionally, the luminous efficiency is slightly low but substantially equal, and the color temperature is a value close to a daylight white color (5000 K).

### EXAMPLE 3

Discharge medium: ZnI₂(10.8)-TlI(10.8)-TmI₃(60.1)-PrI₃(18.3)=0.6 mg, a numerical character in parentheses means a filling ratio (% by mass), Xe 13 atmospheres

Other specifications are the same as Example 1.

Electrical characteristics: lamp voltage 78.0 V, lamp current 0.500 A, lamp power 38.9 W

Luminescent characteristics: total light flux 3446 μm, luminous efficiency 88.6 μm/W, color temperature 5158 K, average color rendering index Ra 81.0

According to Example 3, the electrical characteristics are substantially equal to those in the comparative example, and the average color rendering index Ra in the luminescent characteristics is clearly excellent. Further, the total light flux is substantially equal, the luminous efficiency is low, and the color temperature is a value close to a daylight white color (5000 K).

### EXAMPLE 4

Hermetically sealed vessel 1: maximum external diameter 6.0 mm, spherical length 6.5 mm, maximum internal diameter 2.4 mm, internal volume 0.025 cc

Discharge medium: ZnI₂(13.0)-TlI(7.0)-TmI₃(72.0)-NaI(8.0)=0.8 mg, a numerical character in parentheses means a filling ratio (% by mass), Xe 13 atmospheres

Other specifications are the same as Example 1.

Electrical characteristics: lamp voltage 75 V, lamp current 0.8 A, lamp power 50 W

Luminescent characteristics: total light flux 5000 μm, luminous efficiency 100 μm/W, color temperature 4200 K, average color rendering index Ra 81, color deviation 0.0045

### COMPARATIVE EXAMPLE 2

Discharge medium: Hg 0.2 mg-ScI₃(16.67)-NaI(83.33)=0.7 mg, a numerical character in parentheses means a filling ratio (% by mass), Xe 5 atmospheres

Other specifications are the same as Comparative Example 1

Electrical characteristics: lamp voltage 85.0 V, lamp current 0.71 A, lamp power 50 W

Luminescent characteristics: total light flux 5500 μm, luminous efficiency 111 lm/W, color temperature 4300 K, average color rendering index Ra 65.0

According to Example 4, the electrical characteristics and the luminescent characteristics are substantially equal to those in Comparative Example 2.

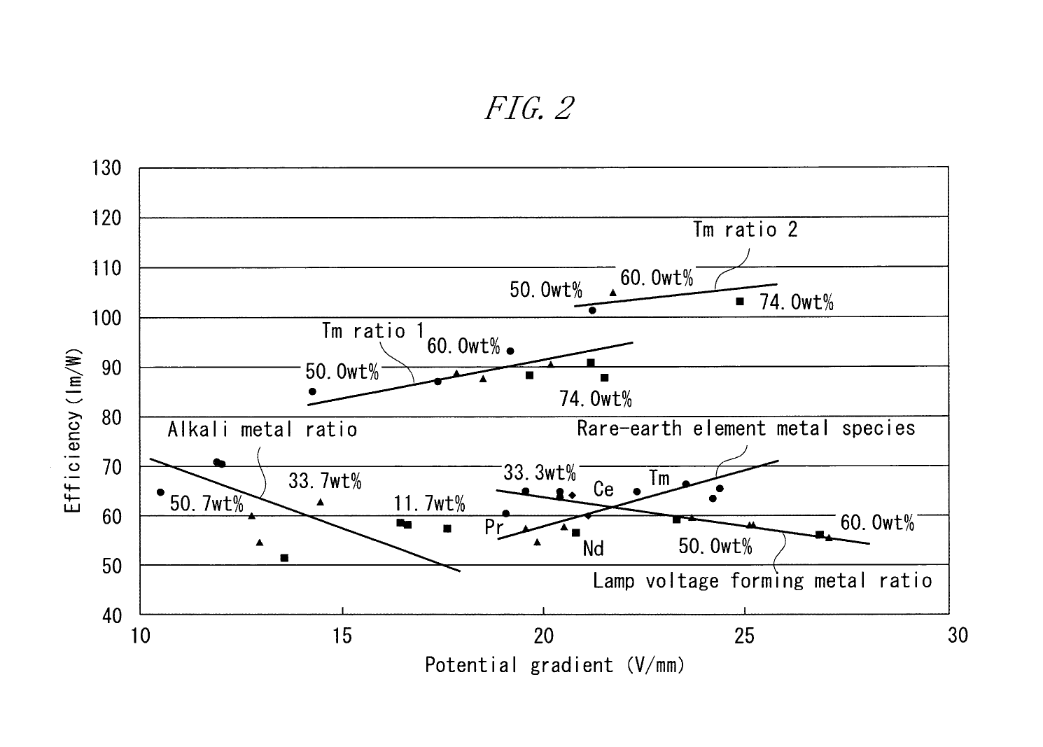

A result of examining how the lamp voltage and the luminous efficiency are affected when types and filling ratios of metal halides to be filled are changed will now be explained with reference to FIG. 2.

FIG. 2 is a graph showing a relationship between a potential gradient and a luminous efficiency with types and filling ratios of metal halides to be filled being used as parameters. In the drawing, an abscissa represents a potential gradient (V/mm), and an ordinate represents an efficiency (lm/W). It is to be noted that the efficiency means a luminous efficiency. Each curve in the drawing is as follows. All curves are created based on data obtained from measurement using metal halide lamps in which discharge mediums are changed in the specifications basically the same as those in Example 1.

Curves “Tm ratio 1” and “Tm ratio 2”: a filling ratio of a thulium halide (TmI₃) is changed in Example 1, and the former curve corresponds to an example where lighting is effected with a lamp power 35 W, and the latter curve corresponds to an example where lighting is performed with a lamp power 49 W.

In regard to a filling ratio of the thulium halide, a symbol closed circle represents 50.0% by mass; a symbol closed triangle, 60.0% by mass; and a symbol closed square, 74% by mass.

A curve “rare-earth element metal species”: a filling ratio by mass of a rare-earth metal halide is 25%, the same of an indium halide InI, 3%; the same of a zinc iodide ZnI₃, 40%; and the same of a thulium halide TlI, 32%, and this curve corresponds to each example where a thulium (Tm) halide, a praseodymium (Pr) halide, a cerium (Ce) halide, or a neodymium (Nd) halide is filled as the rare-earth metal halide. A symbol closed circle represents thulium (Tm); a symbol closed diamond, cerium (Ce); a symbol closed square, neodymium; and a symbol closed triangle, praseodymium.

A curve “lamp voltage forming metal ratio”: a sealing ratio by mass of a thulium halide is 25%; the same of an indium halide, 3%; the same of a zinc iodine ZnI₃, 33.3, 55.0, and 60.0%; the same of a thallium halide TlI, a remnant. Incidentally, in regard to the filling ratio by mass of the zinc iodine ZnI₃, a symbol closed circle represents 33.3%; a symbol closed triangle, 50.0%; and a symbol closed square, 60.0%.

A curve “alkali metal ratio”: a filling ratio by mass of a thulium halide is 25%; the same of an indium halide, 3%; the same of a zinc iodine ZnI₃, 33%; and the same of a thallium halide TlI, 39%, and this curve corresponds to an example where a sodium halide is added to these halides and a filling ratio by mass of the sodium halide is change to 11.7%, 33.7%, or 50.7%. Incidentally, as to a filling ratio by mass of a sodium iodine (NaI), a symbol closed circle represents 50.7%; a symbol closed triangle, 33. %; and a symbol closed square, 11.7%.

The following matters are revealed from FIG. 2. That is, as can be understood from the curves “Tm ratio 1” and “Tm ratio 2”, numerical values of the potential gradient and the efficiency increase as the filling ratio by mass of the thulium halide rises. Further, when a temperature at the coolest portion becomes higher, numerical values of the potential gradient and the efficiency increase.

Referring to the curve “rare-earth element metal species”, numerical values of the potential gradient and the efficiency of the thulium halide are larger than those of the other rare-earth metal halides. Furthermore, these numerical values are increased in the order of Pr, Nd, Ce, and Tm.

As can be understood from the curve “lamp voltage forming metal ratio”, the potential gradient increases as the filling ratio by mass of the zinc iodine (ZnI₃) rises but, on the other hand, a numeral value of the efficiency is decreased.

Referring to the curve “alkali metal ratio”, the luminous efficiency increases as the filling ratio by mass of the sodium iodine (NaI) rises, but the potential gradient is reduced.

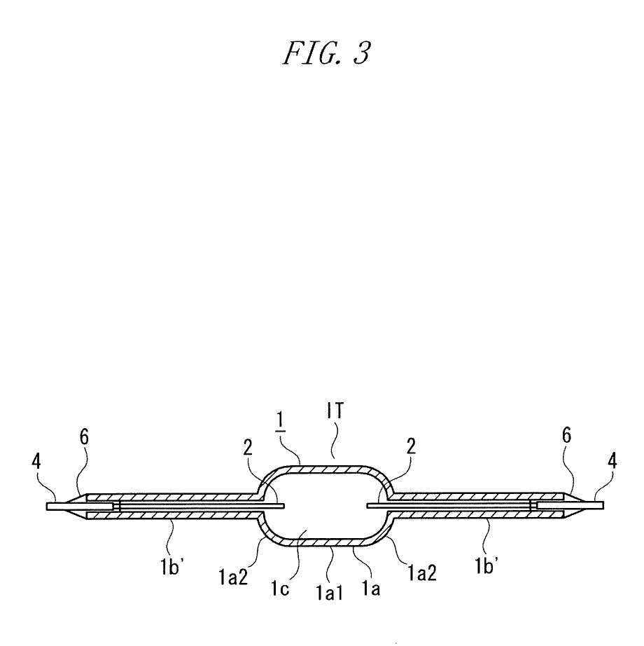

FIG. 3 is a front view showing a second embodiment that carries out a metal halide lamp according to the present invention. This embodiment is a metal halide lamp that can be carried out in the form of a general illumination as an application example of the present invention, and it is constituted of a light-transmitting hermetically sealed vessel 1, a pair of electrodes 2 and 2, a pair of external lead wires 4 and 4, a pair of sealants 6 and 6, and a discharge medium. The light-transmitting hermetically sealed vessel 1, the pair of electrodes 2 and 2, the pair of external lead wires 4 and 4, the pair of sealants 6 and 6, and the discharge medium are integrated to constitute a light-transmitting ceramics arc tube IT, and this arc tube is sealed and disposed in a non-illustrated outer tube to be used.

The light-transmitting hermetically sealed vessel 1 is made of light-transmitting ceramics consisting of light-transmitting alumina ceramics, includes an enclosure portion 1a and a pair of elongated cylindrical portions 1b‘ and 1b’, and formed based on a shrink fitting structure of a plurality of constituent parts mentioned below. The enclosure portion 1a has a rice-bag-like shape, and is formed of a middle cylindrical portion 1a1 and a pair of semispherical portions 1a2 and 1a2 that are continuous on both ends. The cylindrical portion 1b′ has an elongated pipe-like shape, and its distal end communicates with a central part of the semispherical portion 1a2 of the enclosure portion 1a. It is to be noted that an alternate long and short dash line in the drawing is a central axial line indicative of a tube axis position. Showing an example of the arc tube IT, the hermetically sealed vessel 1 has an entire length of 35 mm, the enclosure portion 1a has an external diameter of 6 mm and an internal diameter of 5 mm, and the cylindrical portion 1b′ has an external diameter of 1.7 mm and an internal diameter of 0.7 mm. The electrode 2 has an external diameter of 0.3 mm at a shaft portion, and the external lead wire 4 has an external diameter of 0.65 mm.

The electrode 2 is formed of a rod-like body of doped tungsten, a distal end thereof faces the inside of the enclosure portion 1a of the hermetically sealed vessel 1, a proximal end thereof the same is butt-welded to a distal end of the external lead wire 4, and a middle part thereof is inserted into the cylindrical portion 1b′ while forming a capillary rally as a small gas at the periphery.

The external lead wire 4 is formed of a rod-like body of niobium, and a distal end thereof is inserted into an end of the cylindrical portion 1b′, and a proximal end thereof is led to the outside.

The sealant 5 is made of a vitrificated body of frit glass, i.e., a ceramics compound, and enters the cylindrical portion 1b′ to partially cover the distal end of the external lead wire 4 and the proximal end of the electrode 2.

The discharge medium is the same as that in the first embodiment, but an excess halide H_{G} during lighting has a liquid phase to stay at an illustrated position in the capillary rally. It is to be noted that a coolest portion P_{T} is formed at a distal end of the excess halide H_{G} on a discharge space 1c side.

FIG. 4 is a process diagram showing a procedure when sealing the light-transmitting ceramics arc tube according to the second embodiment depicted in FIG. 3.

The sealing process advances from a process (a) at a left end toward a process (e) at a right end in the drawing.

In the process (a), the sealed vessel 1 is in an unsealed state, and a part surrounded by a dotted line circle of the cylindrical portion 1′ positioned on an upper side in the drawing is first sealed.

In the process (b), an electrode mount M_{E} is inserted from the cylindrical portion 1′ to a predetermined position. It is to be noted that the electrode mount M_{E} is formed by welding the electrode 2 and the external lead wire 4 in advance, and a stopper s is formed at a predetermined position of the external lead wire 4. That is, a position where the stopper s comes into contact with a facet of the cylindrical portion 1b′ is the predetermined insertion position.

In the process (c), a frit glass powder HG molded in a donut-like shape in advance is inserted from an upper side of the external lead wire 4 of the electrode mount M_{E}.

In the process (d), a sealing planned portion including the frit glass powder HG is heated by using, e.g., a laser beam.

In the process (e), when the frit glass powder G is fused, the glass frit enters the cylindrical portion 1b′ from the facet thereof and surrounds the portion in which the external lead wire 4 is inserted. Then, when cooling is effected, sealing of the light-transmitting ceramics arc tube IT is terminated.

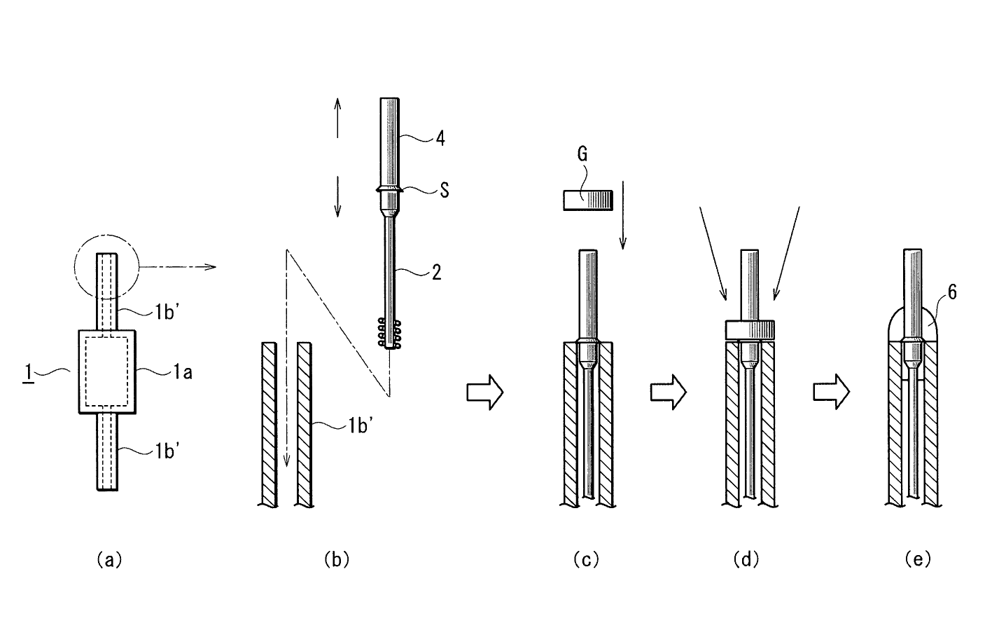

A structural example of a sealing device for the light-transmitting ceramics arc tube IT will now be explained with reference to FIGS. 5 to 7. It is to be noted that like reference numerals denote like parts in each drawing.

FIG. 5 is a conceptual view showing a first embodiment of a sealing device for the hermetically sealed vessel made of light-transmitting ceramics.

In the drawing, reference numeral 11 denotes a sealing chamber; 12, a dry box; 13, a YAG laser; 14, an optic fiber; 15, a laser head; 16, an exhaust system; 17, a filled gas system; and IT, a light-transmitting ceramics arc tube. It is to be noted that using the YAG laser as a laser beam source 13 facilitates heating the hermetically sealed vessel 1, thereby effecting excellent sealing.

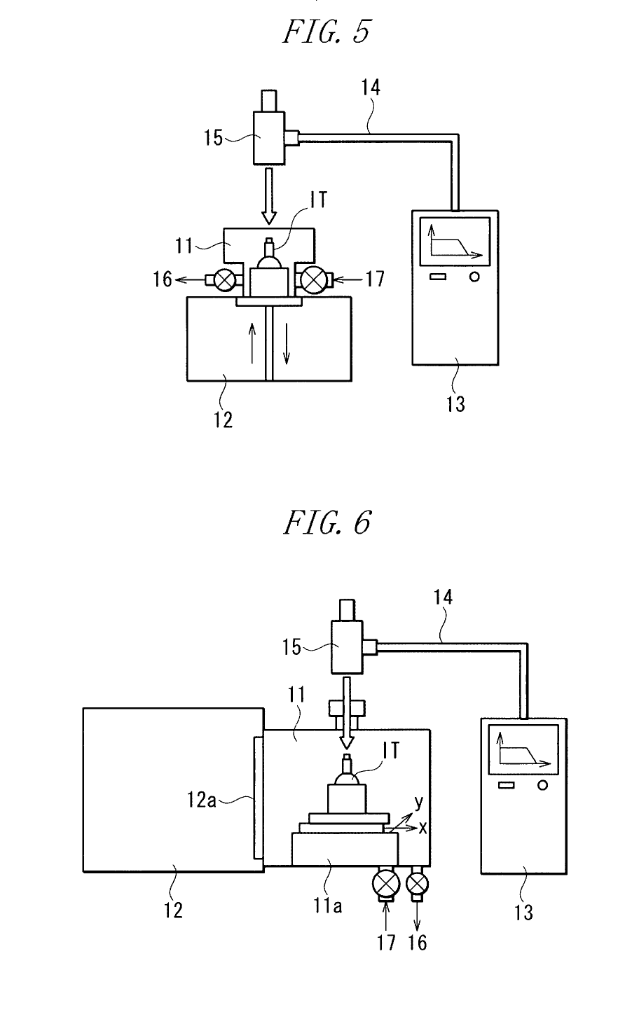

FIG. 6 is a conceptual view showing a second embodiment of a sealing device for the hermetically sealed vessel made of light-transmitting ceramics.

In this embodiment, a sealing chamber 11 includes an xy stage therein. Moreover, a door is arranged between the sealing chamber 11 and a dry box 12.

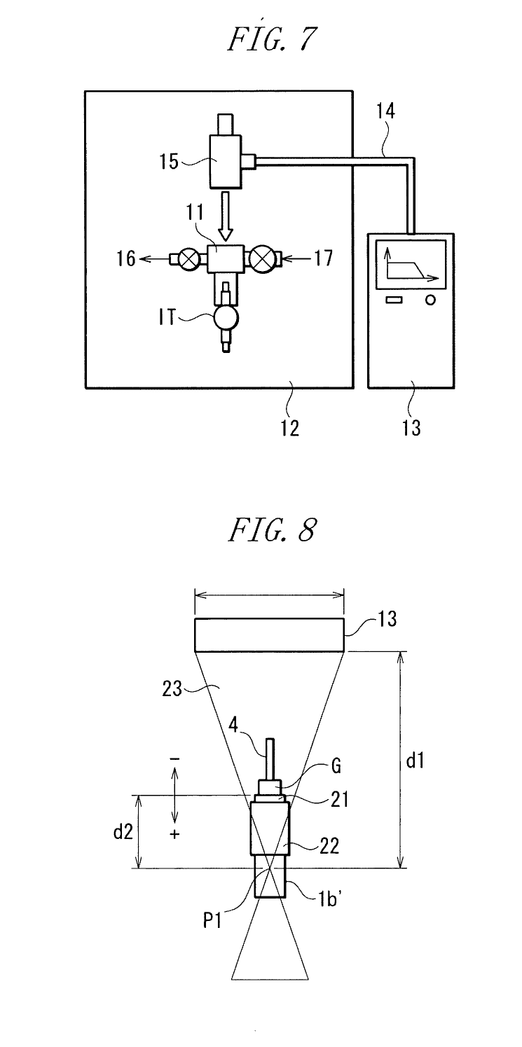

FIG. 7 is a conceptual view showing a third embodiment of a sealing device for the hermetically sealed vessel made of light-transmitting ceramics. In this embodiment, a sealing chamber 11 locally encloses a sealing portion alone in the hermetically sealed vessel IT made of light-transmitting ceramics, and a dry box 12 accommodates the sealing chamber 11, a laser head 15, an exhaust system 16, and a filled gas system 17.

A conformation of sealing of the hermetically sealed vessel made of light-transmitting ceramics will now be explained. It is to be noted that, in the drawing, like reference numerals denote parts equal to those in FIG. 3, thereby omitting an explanation thereof.

FIG. 8 is a conceptual front view showing a first embodiment of sealing of the hermetically sealed vessel made of light-transmitting ceramics. In this embodiment, in order to prevent a part except a sealing planned portion 21 and a frit glass powder G in the cylindrical portion 1b′ of the hermetically sealed vessel 1 from being undesirably heated, a portion adjacent to the sealing planned portion 21 in the cylindrical portion 1b′ is heated by a laser beam 23 while being surrounded by a cylindrical endothermic member 22.

Since the endothermic member 22 absorbs heat when heating the sealing planned portion 21, a region of the cylindrical portion 1b′ adjacent to the sealing planned portion 21 that is not irradiated with a laser beam is also heated and its temperature increases. As a result, the frit glass readily enters the cylindrical portion 1b′, thereby forming the excellent sealing portion.

It is to be noted that the laser beam 23 converges on a focal point P1. Further, when a change in the focal point position P1 of the laser beam 23 is allowed in a vertical direction to enable adjustment of a focal distance d1, a defocus distance d2 is changed, thereby adjusting a degree of heating with respect to the sealing planned portion 21. It is to be noted that reference numeral 13 in the drawing in the drawing denotes a laser head.

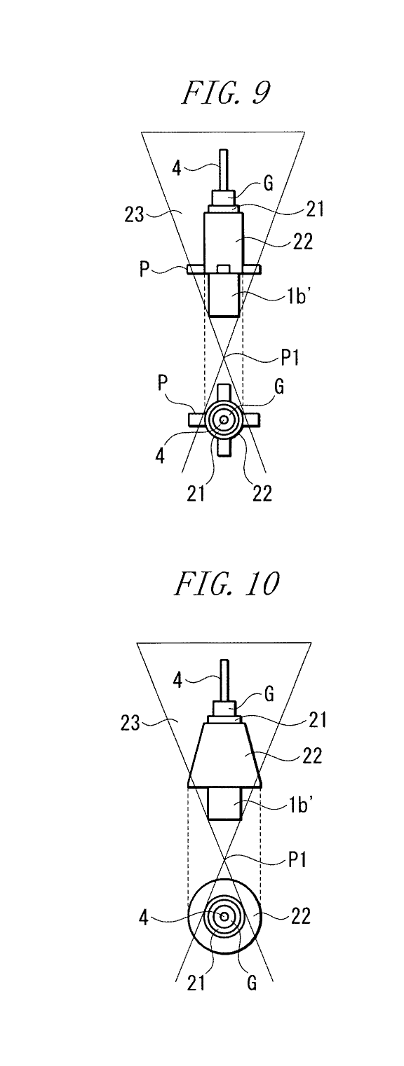

FIG. 9 is a conceptual front view and plan view showing a second embodiment of sealing of the hermetically sealed vessel made of light-transmitting ceramics. This embodiment is different from the first embodiment depicted in FIG. 8 in that projections p are provided at the periphery of a lower part of a cylindrical endothermic member 22 at intervals of 90°.

FIG. 10 is a conceptual front view and plan view showing a third embodiment of sealing of the hermetically sealed vessel made of light-transmitting ceramics. In this embodiment, an endothermic member 22 has a truncated conical shape, and facilitates and assures heat shielding with respect to the part of the hermetically sealed light-transmitting ceramics vessel positioned below the endothermic member 22, thereby avoiding an undesired increase in temperature of this part.

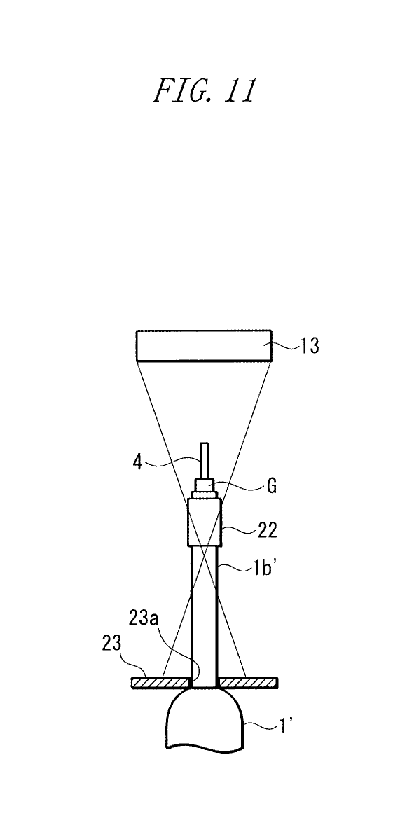

FIG. 11 is a conceptual partially cross-sectional front view showing a fourth embodiment of sealing of the hermetically sealed vessel made of light-transmitting ceramics. In this embodiment, an endothermic member 22 has a cylindrical shape like a counterpart depicted in FIG. 8, but a heat shielding member 23 is fitted at a boundary between the enclosure portion 1a and the cylindrical portion 1b′ of the hermetically sealed light-transmitting ceramics vessel to effect sealing. As a result, the heat shielding member 23 prevents application of a laser beam to the enclosure portion la of the hermetically sealed light-transmitting ceramics vessel positioned below the heat shielding member 23.

It is to be noted that the heat shielding member 23 is formed of a donut-like disc having heat shielding material, and has a through hole 23a that allows loose insertion into the cylindrical portion 1b′ at the central part.

Therefore, the enclosure portion 1a of the hermetically sealed light-transmitting ceramics vessel is not undesirably heated at the time of sealing.

### INDUSTRIAL APPLICABILITY

The present invention can be applied to not only a vehicle headlight but also various applications, e.g., a general illumination.

1. A metal halide lamp comprising:
a light-transmitting hermetically sealed vessel having a discharge space therein;
a pair of electrodes that are sealed and disposed in the hermetically sealed vessel and face the discharge space; and
a discharge medium containing a first halide, a second halide, and a rare gas, the first halide being mainly composed of a halide of a luminescent metal and containing a thulium (Tm) halide at the highest filling ratio in all of metal halides filled in the hermetically sealed vessel, a content of an alkali metal halide being less than 10% by mass, the second halide being mainly composed of a metal halide that forms a lamp voltage, a content of the second halide being 5 to 20% by mass with respect to all the metal halides filled in the hermetically sealed vessel, the discharge medium being filled in the hermetically sealed vessel without substantially containing mercury.

2. The metal halide lamp according to claim 1, wherein the alkali metal halide in the discharge medium mainly contains one or more halides selected from a group including sodium (Na), cesium (Cs), and lithium (Li).

3. A metal halide lamp comprising:
a light-transmitting hermetically sealed vessel having a discharge space therein;
a pair of electrodes that are sealed and disposed in the hermetically sealed vessel and face the discharge space; and
a discharge medium containing a first halide, a second halide and a rare gas, the first halide being mainly composed of a halide of a luminescent metal and containing a thulium (Tm) halide at the highest filling ratio in all metal halides filled in the hermetically sealed vessel, the second halide being mainly composed of a metal halide that forms a lamp voltage, a content of the second halide being 5 to 20% by mass with respect to all the metal halides filled in the hermetically sealed vessel, ionization potentials of metals forming all the metal halides being not lower than 5.4 eV, and the discharge medium being filled in the hermetically sealed vessel without substantially containing mercury.

4. The metal halide lamp according to one of claims 1 to 3, wherein a filling ratio H_{Tm} (% by mass) of the thulium (Tm) halide in the discharge medium with respect to all the metal halides filled in the hermetically sealed vessel satisfies the following expression:
30<H_{Tm}<90

5. The metal halide lamp according to one of claims 1 to 4, wherein the first halide in the discharge medium contains one or more halides of rare-earth metals selected from a group including praseodymium (Pr), cerium (Ce), and samarium (Sm), and a filling ratio of the rare-earth metal halides as well as the thulium (Tm) halide with respect to all the halides is not smaller than 50% by mass.

6. The metal halide lamp according to one of claims 1 to 5, wherein the first halide in the discharge medium contains at least one of a thallium (Tl) halide and an indium (In) halide.

7. A lighting equipment comprising:
a lighting equipment main body;
a metal halide lamp according to one of claims 1 to 6 that is arranged in the lighting equipment main body; and
a lighting device that turns on the metal halide lamp.
